(19) United States
(12) Patent Application Publication
(10) Pub. No.: US 2010/0234168 A1
(43) Pub. Date: Sep. 16, 2010

(54) Multiple-Ratio Individual-Activation Transmission Device

(76) Inventors: Roumen Antonov, Paris (FR); Cyril Mougeot, Bazoches sur le Betz (FR)

Correspondence Address: KENYON & KENYON LLP, ONE BROADWAY, NEW YORK, NY, 10004, US

(21) Appl. No.: 12/223,227

(22) PCT Filed: Jan. 26, 2007
(86) PCT No.: PCT/FR2007/000151

§ 371 Date: Jun. 9, 2009

(30) Foreign Application Priority Data
Jan. 27, 2006 (FR) 06 00742

(51) Int. Cl. F16H 3/44

(52) U.S. Cl. 475/296

(57) ABSTRACT

The invention concerns a multiple ratio transmission device with permanent meshing, in particular for making a gearbox capable of providing gear shifts without interrupting the power transmission, for example an automatic control or sequential control gearbox. Said device comprises three coaxial planetary trains using selective coupling means so that each provides local direct drive or at least one transmission ratio. According to the invention, said device comprises two coaxial planetary trains (TP1, TP2) belonging to two different power paths (8a and 8b) between an upstream rotary member and a downstream rotary member. Said device comprises two gear-type transfer elements (TR1, TR2) of different ratios, interposed between one of the rotary members and one of said planetary trains (TP1, TP2).

This invention relates to a constant-mesh multiple-ratio transmission device, in particular for realizing a gearbox capable of carrying out changes of gear (gear shiftings) without interrupting the power transmission. This invention relates in particular to gearboxes with automatic control or sequential control. This device comprises coaxial planetary gearsets using selective-coupling means in order to each provide one local direct drive or at least one transmission ratio.

In the field of transmission devices, multiple-ratio devices are frequently used to drive a load from a source of mechanical energy. A typical case is that of a gearbox used between a heat engine and a load to be set in motion, in particular the driving wheels of a motor vehicle.

More specifically, in order to realize automatic or sequential-control gearboxes, gearboxes using planetary gearsets, for example epicyclic gearsets, are known.

Document EP 0 434 525 describes a gearbox using a double planetary gearset, of epicyclic type or Ravigneaux type. This gearbox uses five coupling devices (two brakes and three clutches) to realize six forward gears and one reverse gear. Each ratio is obtained by jointly activating two of the five couplings.

This type of gearbox does have certain drawbacks, however. In particular, the joint activation of these two couplings necessitates a synchronization of their control. In particular, this type of transmission cannot comfortably “skip a gear”, i.e. shift from one gear to another which is not the gear immediately below or above it. For these reasons it is also difficult to use these couplings to start the vehicle from stationary, which means that this type of device is most often used in series with an upstream clutch or torque converter.

This type of transmission device currently fits a certain number of recent vehicles.

Document WO 2005/050060 describes a transmission device with five forward gears plus reverse gear. This device uses two planetary gearsets fitted along two parallel layshafts. On the input shaft, a single driving transfer pinion meshes with two driven transfer pinions each situated on one of the layshafts and each driving the input element of a planetary gearset.

Each planetary gearset comprises a clutch realizing a local direct drive, and two epicyclic gearsets each delivering a transmission ratio by locking one of their elements by means of a respective brake. One of these planetary gearsets is constituted by two epicyclic gearsets each with two planets in cascade, one ratio of which forms the reverse gear. The number of local direct drives is therefore equal to the number of layshafts and a respective epicyclic gearset is needed for each ratio except two. In other words, there are four epicyclic gearsets for a total of six ratios (five forward and one reverse). For each ratio other than the local direct drives, power is transmitted by one epicyclic gearset and two meshing transfers.

The invention aims to overcome the drawbacks of the prior art, in particular by improving capacities and performances compared with the currently known transmissions.

The invention seeks in particular to achieve at least one of the following objectives:
to obtain a larger number of ratios,
to obtain a better flexibility of design in the choice of ratios to be realized,
to limit or reduce the space occupied by the device, or adapt it to its environment,
to simplify and make reliable the selection and control of the ratios,
to improve operating reliability and flexibility,
to improve the transmission performance, or
to limit or reduce the number of pinions or sets of teeth to be realized.

For this, the invention proposes a multiple-ratio transmission device comprising:
a frame;
an upstream rotary element and a downstream rotary element;
two coaxial planetary gearsets belonging to two different power paths between the upstream rotary element and the downstream rotary element;
two meshing transfers having different transfer ratios, located between on the one hand one of the upstream and downstream rotary elements and on the other the respective one of said planetary gearsets; and
selective-coupling means to make each planetary gearset operate selectively in local direct drive or according to at least one different transmission ratio;

Thus, the invention makes it possible in particular to obtain a larger number of ratios by limiting the amount of space occupied and the complexity, since the direct drives of the two planetary gearsets deliver different transmission ratios because these gearsets are fitted operatively in series with meshing transfers defining different transfer ratios.

The invention offers the possibility of realizing several local direct drives without having to provide a corresponding number of layshafts, and even, as will be seen later, without any layshaft at all, according to one embodiment. Realization is simplified, and the number of ratios operating with relatively few meshings is increased. The number of pinions and the number of shafts are reduced. The weight, bulk and cost are therefore also reduced.

At the same time, there is a reasonable number of ratios which are realized by epicyclic gearsets operating with a local ratio other than 1:1. These ratios are preferably the lower ratios of the transmission device (i.e. those for which the speed of the downstream element is lower for a given speed of the upstream element). This is very advantageous for control, as will be seen later.

According to an embodiment which can be qualified as longitudinal, the two planetary gearsets are coaxial with one of the upstream or downstream rotary elements, and the meshing transfers are each operatively mounted between the one respective planetary gearset and the other of said rotary elements, downstream or upstream respectively.

It is in particular in such an embodiment that the layshafts are no longer at all necessary.

Preferably, the device comprises, between the upstream rotary element and the downstream rotary element, at least one third power path comprising a third planetary gearset, capable of a direct drive and coaxial with the two coaxial planetary gearsets, and which is operatively mounted in series with a third meshing transfer defining, between the upstream rotary element and the downstream rotary element, when the third planetary gearset is in direct drive, a transmission ratio different from each of those defined by the two above-mentioned meshing transfers when their respective planetary gearset is in a state of direct drive.

The local direct drive of this third planetary gearset thus delivers a new overall ratio that is different from the two others obtained by the direct drives of the two other planetary gearsets.

According to another embodiment, which can be qualified as “transverse”, the transmission device comprises a third planetary gearset, capable of direct drive and having an axis different from that of the two above-mentioned coaxial planetary gearsets, and which is operatively mounted in series with a third meshing transfer defining, between the upstream rotary element and the downstream rotary element, when the third planetary gearset is in direct drive, a transmission ratio different from each of those defined by the two above-mentioned meshing transfers when their respective planetary gearset is in direct drive.

Here too, the local direct drive of this third planetary gearset thus delivers a new overall ratio that is different from the two others obtained by the direct drives of the two other planetary gearsets.

Moreover, this embodiment allows a particularly compact gearbox to be realized, in particular in terms of length along the direction of the shafts. By way of example, a gearbox designed for a torque of 250 Nm can be realized with a longitudinal space requirement of less than 360 mm, or even 350 mm, as against at least 380 to 390 mm for a standard box such as is described in document EP 0 434 525 B1 which has an equivalent number of ratios.

Moreover, the two first coaxial planetary gearsets can be mounted about a first intermediate axis, and the third planetary gearset is mounted about a second intermediate axis.

According to another feature of this embodiment, a first of the two coaxial transfers and the third transfer comprise a common toothed wheel on one of the upstream or downstream rotary elements, meshing with two pinions each mounted on the respective intermediate axis.

The two transfers linked with the two coaxial planetary gearsets can also comprise two toothed wheels integral with a same upstream or downstream rotary element.

More particularly, at least two of the power paths each passing through two different axes are connected on the one hand to one of the upstream or downstream rotary elements by the above-mentioned transfers and on the other hand to the other of the upstream or downstream rotary elements by meshing according to different or identical local transmission ratios.

This feature allows in particular a good flexibility in the choice of ratios when designing the gearbox.

Other particular features and advantages of the invention will emerge from the detailed description of embodiments that are in no way limiting, and the attached drawings where:

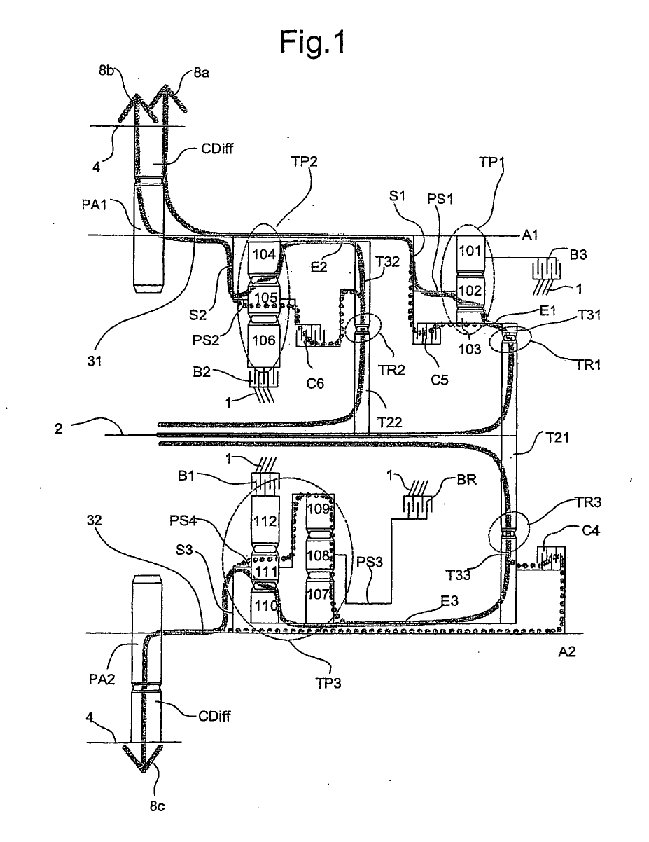

FIG. 1 schematically illustrates an embodiment of the invention delivering six forward ratios and a reverse ratio, arranged transversely with two layshafts, on each of which the planetary gearsets are shown in half-view only;

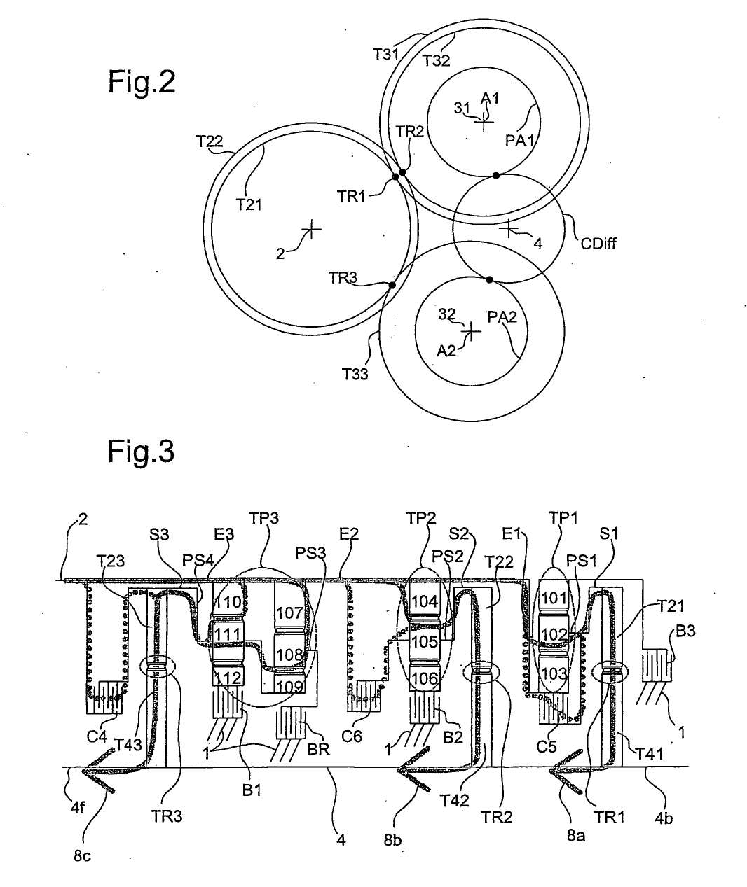

FIG. 2 is an end-view schematically illustrating the organization of the different shafts of a so-called transverse arrangement having two layshafts according to FIG. 1; and

FIG. 3 schematically illustrates an embodiment of the invention delivering six forward and one reverse ratio, in a so-called longitudinal arrangement, where the planetary gearsets, shown in half-view, are coaxial with the input shaft.

In the embodiment of FIGS. 1 and 2, the transmission device according to the invention comprises an upstream rotary element 2 constituted by an input shaft, which is typically permanently connected, in service, to the power shaft of a vehicle engine, in particular an internal combustion engine, without interposition of a clutch or other variable coupling device such as a torque converter. In other words, the typical link between the shaft 2 and the engine is such that any rotation of the engine shaft is necessarily accompanied by a rotation of the shaft 2, and the shaft 2 is stationary only if the engine shaft is immobile.

The transmission device also comprises a downstream rotary element 4 constituted here by an output shaft intended to be connected to the driving wheels of a motor vehicle via a differential, or being able to itself constitute an input shaft of this differential. The connection between the shaft 4 and the driving wheels of the vehicle is typically such that at least one driving wheel turns when the shaft 4 turns. To make FIG. 1 clear, the output shaft 4 is represented at both top and bottom of the figure and two intermediate axes A1 and A2 which will be described below are represented in the same plane, i.e. the plane of FIG. 1, as the axes of the elements 2 and 4. In reality, the shafts 2 and 4 and the two intermediate axes A1 and A2 are at the four points of a quadrilateral, as FIG. 2 shows.

At least during operation according to its “lower” ratios, the device is used for demultiplication (i.e. reduction) of the rotary speed of the upstream element 2 into a lower speed of the downstream element 4, and consequently for increase of the transmitted torque.

The transmission device connects the input shaft 2 to the output shaft 4 along three power paths 8a, 8b and 8c, symbolized by arrows. These paths are operatively in parallel with each other between the rotary elements 2 and 4. Each path 8a, 8b or 8c passes through a respective one of three planetary gearsets TP1, TP2 and TP3.

In the transverse embodiment of FIGS. 1 and 2, the three planetary gearsets TP1, TP2 and TP3 are arranged along the intermediate axes A1 and A2 which are parallel to the axes of the upstream and downstream rotary elements 2 and 4 but which are not coaxial therewith.

The first two planetary gearsets TP1 and TP2 are mounted along a first intermediate axis A1, and the third planetary gearset TP3 is arranged along a second intermediate axis A2.

Between the input shaft 2 and an input element E1, E2 or E3 of each planetary gearset TP1, TP2 or TP3 respectively, there is a respective meshing transfer TR1, TR2 or TR3. The pairs T21-T31, T22-T32 and T21-T33, have different transfer ratios.

A driving transfer pinion T21 integral with the upstream element 2, forming part of the transfers TR1 and TR3, meshes with two driven transfer pinions T31 and T33, respectively arranged along the two intermediate axes A1 and A2 and integral with the inputs E1 and E3 respectively. In order that the toothed wheels T31 and T33 have different diameters, the intermediate axes A1 and A2 are at different distances from the input shaft.

On the other hand, a driving transfer pinion T22 integral with the upstream element 2 and forming part of the transfer TR2 meshes with a driven transfer pinion T32, arranged on the first intermediate axis A1 and integral with the input E2.

The outputs S1, S2 and S3 of the three planetary gearsets are drive-connected to a layshaft 31 or 32 which is itself connected to a ring gear CDiff integral with the downstream rotary element 4. In this example, the ring gear CDiff is the ring gear driving the rotary box of the differential driving the driving wheels of the vehicle.

The outputs S1 and S2 of the first two planetary gearsets TP1 and TP2 are integral with a first 31 of the layshafts which is integral in rotation with a first output pinion PA1 which meshes with the ring gear CDiff of the differential. In this example, the outputs S1 and S2 are therefore integral in rotation relative to each other. The output S3 of the third planetary gearset TP3 is integral in rotation with the second 32 of the layshafts which is fitted with a second output pinion PA2, which itself also meshes with the ring gear CDiff of the differential 4. The layshafts 31 and 32 extend along the intermediate axes A1 and A2 respectively.

The transmission device further comprises a certain number of selective-coupling devices BR, B1, B2, B3, C4, C5, C6 which will be described in detail below. The design is such that each transmission ratio is realized by activation, i.e. placing in coupled state, of just one of the selective-coupling means, and deactivation, i.e. placing or maintaining in uncoupled state all the other selective-coupling means. The “neutral” state in which the rotary elements 2 and 4 are independent of each other is obtained by deactivation of all the selective-coupling means.

The different selective-coupling means are here realized in the form of friction multi-disk mechanisms in an oil bath. These means are called “brakes” when their activation realizes the coupling of a mobile element with the frame 1 or any item integral with the latter. These means are called “clutches” when their activation realizes the mutual coupling of two rotary elements in order that these turn integral with each other.

The first planetary gearset TP1 comprises a first epicyclic gearset coaxial with the first intermediate axis A1. This epicyclic gearset comprises a pinion forming a central sun wheel 101, meshing with one or more eccentric planet wheels 102. These planets 102 are mounted for idling rotation on the arms of a planet carrier PS1, and themselves mesh with a ring gear 103 coaxial with the sun wheel 101, with the planet carrier PS1 and with the axis A1.

Within this first epicyclic gearset, the ring gear 103 is integral with the input E1, and therefore with the driven transfer pinion T31. The ring gear 103 is thus permanently drive-connected to one of the upstream and downstream rotary elements, in this case the input shaft 2.

The planet carrier PS1 is integral with the output S1 and therefore with the first layshaft 31. The planet carrier PS1 is thus permanently drive-connected to the other of the upstream and downstream rotary elements, that is to say the downstream element 4.

A clutch C5 allows selective coupling and uncoupling of the ring gear 103 with the planet carrier PS1, and therefore of the input E1 with the output S1. When the clutch C5 is in coupling state, the first planetary gearset TP1 is in direct local drive state between its input E1 and its output S1.

The geometry of the first transfer TR1 and of the first output pinion PA1 then delivers an overall transmission ratio, corresponding in this example to the fifth ratio.

A brake B3, mounted operatively between the sun wheel 101 and the frame 1, allows selective locking and release of the rotation of the sun wheel 101 relative to the fixed frame 1. When the sun wheel 101 is locked, the rotation of the ring gear 103 drives the planet carrier PS1 according to a local gear reduction ratio determined by the geometry of this epicyclic gearset.

When the brake B3 is locked, the geometry of the epicyclic gearset combines with those of the first transfer TR1 and the first output pinion PA1 to give an overall transmission ratio, corresponding in this example to the third ratio.

The second planetary gearset TP2 comprises a second epicyclic gearset coaxial with the first intermediate axis A1. This second epicyclic gearset comprises eccentric planets 105 mounted for idling rotation on the arms of a planet carrier PS2. Planets 105 mesh with a central sun wheel 104 and with a ring gear 106 coaxial with the sun wheel 104, the planet carrier PS2 and the axis A1. The central sun wheel 104 is integral in rotation with the input E2 of the planetary gearset TP2, and is thus permanently connected to one of the upstream and downstream rotary elements, in this case the upstream rotary element 2.

The planet carrier PS2 is integral with the output S2 and therefore with the first layshaft 31. It is therefore permanently connected in this way to one of the upstream and downstream rotary elements, in this case the output element 4.

A brake B2, mounted operatively between the ring gear 106 and the frame 1, makes it possible selectively to lock and release the rotation of the ring gear 106 relative to the fixed frame 1.

When the ring gear 106 is immobilized, the sun wheel 104, driven by the input shaft 2, drives the planet carrier PS2 according to a local gear reduction dependent on the geometry of the epicyclic gearset, the transfer element TR2 and the gear ratio between Pa1 and CDiff. By activating the brake B2 an overall transmission ratio is thus created, constituting second gear in the present example.

A clutch C6 mounted operatively between the input E2 and the output S2 of the second planetary gearset TP2 makes it possible to selectively operate the planetary gearset TP2 in local direct drive when the clutch C6 is closed, or to cause the input E2 and the output S2 to run at different speeds, in particular for second-gear operation when the brake B2 is closed.

The local direct drive in the second planetary gearset TP2 delivers an overall ratio determined by the geometry of the second transfer TR2 and the first output pinion PA1. In this example, this overall ratio is the sixth gear.

The third planetary gearset TP3 comprises a third and a fourth epicyclic planetary gearset, coaxial with each other and with the second intermediate axis A2.

These two epicyclic gearsets have a common input E3 and a common output S3. The common input E3 is integral with the driven transfer wheel T33. The common output S3 is integral with the second layshaft 32 and therefore with the output pinion PA2.

The third epicyclic gearset comprises one or more eccentric planet pinions 108 mounted loose for idling rotation on the arms of a planet carrier PS3. The planets 108 mesh on the one hand with a central sun wheel 107 and on the other hand with a ring gear 109 coaxial with the sun wheel 107 and with the layshaft 32.

The fourth epicyclic gearset comprises one or more eccentric planet pinions 111 mounted for idling rotation on the arms of a planet carrier PS4. The planets 111 mesh on the one hand with a central sun wheel 110 and on the other hand with a ring gear 112 coaxial with the sun wheel 110 and with the layshaft 32.

The central sun wheels 107 and 110 of these third and fourth epicyclic gearsets are both integral with the common input E3, and therefore with the driven transfer wheel T33.

The ring gear 109 of the third epicyclic gearset and the planet carrier PS4 of the fourth epicyclic gearset are integral with the common output S3 and therefore with the second layshaft 32.

The planet carrier PS3 of the third epicyclic gearset 107 to 109 is free with respect to both the common input E3 and the common output S3, and can be selectively immobilized with respect to the frame 1 by means of one of the selective-coupling means, the brake BR, for realizing a reverse gear.

When the planet carrier PS3 is immobilized, the sun wheel 107 connected to the input E3 drives the ring gear 109 at a reduced speed and in reverse direction, using the planets 108. The ring gear 109 then drives the common output S3 and therefore the second layshaft 32, thus achieving a reverse running gear.

The ring gear 112 of the fourth epicyclic gearset is free with respect to both the common input E3 and the common output S3 and can be selectively locked and released in rotation relative to the frame 1 by means of one of the selective-coupling means, the brake B1. When the ring gear 112 is immobilized, the sun wheel 110, connected to the input E3, drives the planet carrier PS4 according to a local gear reduction dependent on the geometry of the epicyclic gearset.

By activating the brake B1 and releasing the other selective-coupling means, an overall transmission ratio is thus created dependent on the geometry of the epicyclic gearset, the third transfer TR3 and the second output pinion PA2. This overall ratio in the present example constitutes a first gear.

Moreover, the clutch C4, forming part of the selective-coupling means, selectively couples and uncouples the input E3 and the output S3 with respect to each other. When the clutch C4 is activated, the planetary gearset TP3 operates in local direct drive procuring a transmission ratio, here the fourth gear, which depends on the ratio of the transfer TR3 to the gear ratio PA2-CDiff.

According to a variant not shown here, the output pinions PA1 and PA2 of the layshafts 31 and 32 can have different dimensions and contribute to determining different ratios.

The longitudinal embodiment illustrated in FIG. 3 is described only where it differs from the preceding one.

The three planetary gearsets TP1, TP2 and TP3 are coaxial with the input shaft 2, and the gearing transfers TR1, TR2 and TR3, the transfer ratios of which are different, are each mounted operatively between the output S1, S2 or S3 of the respective one of the planetary gearsets and the output shaft 4. The output shaft 4 is integral with three driven transfer pinions T41, T42, T43 which mesh respectively with driving transfer pinions T21 integral with the output S1, T22 integral with the output S2, and T23 integral with the output S3. The driving pinions T21, T22, T23 are coaxial with the input shaft 2. There is no longer any intermediate axis A1 and A2, nor any layshaft 31, 32.

The input shaft 2 is permanently integral in rotation with the inputs E1, E2 and E3 of the three planetary gearsets TP1 TP2 and TP3.

In the example shown in FIG. 3, where the shaft 4 is connected to the drive wheels by its left end 4f, there can be seen, from left to right, firstly the planetary gearset TP3 producing the highest torque (in Nm), then the planetary gearset TP2, the smallest ratio of which is the second gear, then the planetary gearset TP1 the smallest ratio of which is the third gear.

Thus, the shaft 4 needs a cross section adequate for the maximum torque transmissible to the wheels only in the region situated to the left of the driven transfer pinion T43. A cross section of intermediate value between the driven transfer pinions T42 and T43 is adequate, and a cross section with a lower value between the driven transfer pinions T41 and T42 is adequate. But it is also possible to envisage, as illustrated in FIG. 3, that the right end 4b is itself also connected to the drive wheels, instead of the end 4f, or in addition to the end 4f.

The input element 2 is connected to the engine shaft (not shown) also on the left side of FIG. 3, therefore on the same side as the connection of the output element 4 to the differential (not shown), and on the same side as the planetary gearsets TP2 and TP3 the input elements of which E2, E3 are integral with the central sun wheels 104, and respectively 107 and 110. The architecture is thus considerably simplified, as illustrated in FIG. 3.

Each overall ratio obtained by direct drive in a planetary gearset TP1, TP2 or TP3 is equal to the corresponding transfer ratio TR1, TR2 or TR3. Each overall ratio obtained by a gear reduction operation in a planetary gearset TP1, TP2 or TP3 is equal to the corresponding transfer ratio multiplied by the local gear reduction ratio in the planetary gearset, a brake B1, B2, B3 or BR of which is activated.

In the two embodiments described here, the upstream and downstream rotary elements are connected to each other by permanent gear meshes. The changes of gear ratio are not carried out by operating synchronizers or dog-clutches, but by oil bath clutches or brakes which allow smooth transitions between the ratios, without interrupting the power transmission. Gear shift control is simplified, as no clutch is necessary between the vehicle engine and the input element 2. The efficiency is not reduced by a torque converter.

As mentioned above in detail, each transmission ratio is realized by closing a single selective-coupling means of one of the planetary gearsets TP1, TP2, TP3 and by opening or maintaining in an open state the other selective-coupling means of the transmission device. This simplifies the control and allows in a fairly simple manner a joint regulation of the pressure increase in the hydraulic chamber of the selective-coupling means in the process of closing, and of the pressure decrease in the hydraulic chamber of the selective-coupling means in the process of opening. Such a regulation makes it possible to avoid surges on the one hand, and to avoid or limit power flow interruption through the transmission on the other hand.

It is possible to skip one or more gears, simply by releasing the current coupling and directly controlling the activation of the coupling corresponding to the chosen gear which is not contiguous with the previous gear.

More particularly, the selective-coupling means B1, B2, B3, C4, C5, C6 and BR are of the progressive type and are capable of ensuring progressive adaptation between the speed of rotation of a vehicle engine and the speed of the vehicle. Brakes B1 and BR are capable of serving as a means of progressively setting the vehicle in motion from stationary in first forward speed or respectively in reverse.

For this purpose, we start from an initial situation where the input element 2 runs with the vehicle engine and the output element 4 is stationary with the vehicle wheels, all the coupling means being inactive. In order to set vehicle in motion, the brake B1 or the brake BR is closed in the desired progressive manner.

Typically, each of the selective-coupling means comprises an oil bath multi-plate friction device. Each of the two elements to be engaged carries a series of plates. The plates of one of the elements alternate with those of the other element. During the activation, the plates of these two series are pressed against each other by a thrust element, actuated by pressurization of a hydraulic chamber.

In each planetary gearset TP1, TP2 or TP3, the highest forward gear is obtained by activation of a clutch and the lowest gear is obtained by activation of a brake acting on the ring gear (brake B1 or B2) or on the sun wheel (brake B3). The braking torque exerted by these brakes is much lower (approximately 1.5 to 2.5 times lower) than the torque transmitted at the output S1, S2 or S3 of the planetary gearset while operating on the corresponding transmission ratio.

Preferably, the majority of ratios obtained by local direct drives C4, C5, C6 mostly have smaller gear reductions (correspondent to higher ratios) than the ratios obtained by selective coupling BR, B1, B2, B3 between the frame and a planetary gearset element.

In the embodiments here described, only the higher ratios (4th, 5th and 6th) use a clutch-type coupling, i.e. the ratios which produce the lowest torque on the output element 4. The lower ratios (Reverse, 1st, 2nd and 3rd) all use brake-type couplings.

Realization is simpler and more robust, as the brakes are easier to control and cool more efficiently due to the fact that they comprise a fixed part connected to the frame.

By limiting the braking action required from the selective-coupling means, it is also possible to limit hydraulic drag phenomena and the losses and heat generation due to this drag. It is also possible to limit the hydraulic pressure required for control, and therefore the power of the pump which generates it.

In order to activate a gear ratio of the transmission device, it is only necessary to control the activation of a single one of the selective-coupling means, while releasing the others. The neutral is simply obtained by leaving them all free.

In the embodiments here described, the activation of the different brakes and clutches gives the following gears, the values of which are given as examples in the following table where, for each gear ratio, the value of the ratio is indicated in the column showing the activated selective-coupling means:

| | selective-coupling means | | | | | | |
|---|---|---|---|---|---|---|---|
| gears | BR | B1 | B2 | B3 | C4 | C5 | C6 |
| Reverse gear | 3.94 | | | | | | |
| 1^{st} gear | | 4.38 | | | | | |
| 2^{nd} gear | | | 2.59 | | | | |
| 3^{rd} gear | | | | 1.83 | | | |
| 4^{th} gear | | | | | 1.42 | | |
| 5^{th} gear | | | | | | 1.16 | |
| 6^{th} gear | | | | | | | 0.97 |

With respect to numerous known devices, the invention allows in particular greater flexibility in the choice of gear range combined with a limited space requirement of the device.

With respect to the teaching of the document WO 2005/050060 the invention makes it possible in particular to reduce the number of tooth sets to be produced and to improve the compactness and space requirement of the transmission device.

In these various embodiments, adding an additional gear in the form of an additional local direct drive is useful from the point of view of the transmission efficiency. In fact, within a power path, a local direct drive has a better efficiency than a gear drive.

Moreover, by limiting the number of gear meshes acting in series in the different power paths, the invention makes it possible to limit the transmission losses. In comparison with a conventional transmission as described in the document EP 0 434 525, for example, a gain of approximately 5% to 6% in efficiency is noted, which is reflected in the performances and consumption of the engine and of the vehicle.

Of course the invention is not limited to the examples which have just been described and numerous amendments can be made to these examples without exceeding the scope of the invention.

It would be possible to run at least one of the epicyclic gearsets either in a local direct drive ratio or in an overdrive gear, for example by connecting the input of the planetary gearset to its planet carrier, while the sun wheel and the ring gear are linked one with the output and the other to a brake.

In a transverse embodiment different from that of FIGS. 1 and 2, it would be possible to connect each of the outputs S1 and S2 of the planetary gearsets TP1 and TP2 to the output element 4 by a respective meshing transfer having a transfer ratio which is not the same for these two gearsets. The shaft 31 common to the two planetary gearsets is then removed or replaced by a common layshaft integral with the two inputs E1 and E2 of the two gearsets, and driven by a gear pair from the input element 2.

In a longitudinal embodiment different from that of FIG. 3, the outputs S1, S2 and S3 could be integral with the output shaft 4 whilst each of the inputs E1, E2 and E3 would be connected to the input element 2 by a transfer having a different transfer ratio for each gearset TP1, TP2 and TP3. In this case, the gearsets are typically coaxial with the output element 4.

It is very clear that this device can also be used in the other direction, in overdrive gear, and that the terms “upstream” and “downstream” can be exchanged in other configurations.

1. A multiple-ratio transmission device, comprising:
a frame (1);
an upstream rotary element (2) and a downstream rotary element (4);
two planetary gearsets (TP1, TP2) belonging to two different power paths (8a and 8b) between the upstream rotary element and the downstream rotary element;
two meshing transfers (TR1, TR2) having different transfer ratios, located between one (2; 4) of the upstream and downstream rotary elements and the respective one of said planetary gearsets (TP1, TP2); and
selective-coupling means (B1 to B3, C4 to C6, BR) to make each planetary gearset operate selectively in direct local drive (C5 respectively C6) or according to at least one different transmission ratio (B3, respectively B2);
characterized in that the two planetary gearsets (TP1, TP2) are coaxial.

2. A device according to claim 1, characterized in that the two transfers (TR1, TR2) linked with the two coaxial planetary gearsets (TP1, TP2) comprise two toothed wheels (T21, T22; T41, T42) integral with a same (2;4) upstream or downstream rotary element.

3. A device according to claim 1, characterized in that the two planetary gearsets (TP1, TP2) are coaxial with one (2) of the upstream or downstream rotary elements, and the meshing transfers (TR1, TR2) are each operatively mounted between the respective planetary gearset and the other (4) of said rotary elements.

4. A device according to claim 1, characterized by comprising, between the upstream rotary element (2) and the downstream rotary element (4), at least one third power path (8c) comprising a third planetary gearset (TP3), capable of a direct local drive and coaxial with the two coaxial planetary gearsets (TP1, TP2), the third planetary gearset (TP3) being mounted operatively in series with a third meshing transfer (TR3) defining, between the upstream rotary element (2) and the downstream rotary element (4), when the third planetary gearset is in a state of direct local drive, a transmission ratio different from each of those defined by the two above-mentioned meshing transfers (TR1, TR2) when their respective planetary gearset is in a state of direct local drive.

5. A transmission device according to claim 1, characterized by comprising a third planetary gearset (TP3), capable of direct drive and having an axis (A2) different from that (A1) of the two above-mentioned coaxial planetary gearsets (TP1, TP2), the third planetary gearset (TP3) being mounted operatively in series with a third meshing transfer (TR3) defining, between the upstream rotary element (2) and the downstream rotary element (4), when the third planetary gearset is in a state of direct local drive, a transmission ratio different from each of those defined by the two above-mentioned meshing transfers (TR1, TR2) when their respective planetary gearset is in a state of direct local drive.

6. A device according to claim 5, characterized in that the two first coaxial planetary gearsets (TP1, TP2) are mounted along a first intermediate axis (A1), and the third planetary gearset (TP3) is mounted along a second intermediate axis (A2).

7. A device according to claim 6, characterized in that a first (TR1) of the two coaxial transfers and the third transfer (TR3) comprise a common toothed wheel (T21) on one (2) of the upstream or downstream rotary elements meshing with two pinions (T31, T33) each mounted about a respective one of the intermediate axes (A1, A2).

8. A device according to claim 6, characterized in that at least two of the power paths (8a, 8c) each passing through the respective one of the two layshafts (A1, A2) are connected on the one hand to one (2) of the upstream or downstream rotary elements by the above-mentioned transfers and on the other hand to the other (4) of the upstream or downstream rotary elements by meshing according to different transmission ratios (PA1, PA2).

9. A device according to claim 1, characterized in that one (TP3) of the planetary gearsets comprises at least two epicyclic gearsets having a common input (E3) and a common output (S3),
one (107 to 109) of these epicyclic gearsets having a planet carrier (PS3) which is free in relation to both the common input (E3) and the common output (S3) and being able to be immobilized with respect to the frame by means of one of the selective-coupling means (BR) to produce a reverse gear,
the other (110 to 112) of these epicyclic gearsets having a planet carrier (PS4) permanently connected to one (S3) of said common input and output, and being able to produce two forward ratios, each by activation of a respective one (B1, C4) of the selective-coupling means.

10. A device according to claim 1, characterized in that at least one of the planetary gearsets (TP1; TP2; TP3) comprises an epicyclic gearset comprising:
a planet carrier (PS1; PS2; PS4) permanently connected, at least indirectly, to a first (4) of the upstream and downstream rotary elements, and capable of being selectively connected, at least indirectly, to the second (2) of said upstream and downstream rotary elements by one (C5; C6; C4) of the selective-coupling means, thus forming a direct local drive;
a sun wheel (101; 104; 110) and a ring gear (103; 106; 112), one (103; 104; 110) of which is permanently connected to said second (2) rotary element; and the other (101; 106; 112) of which can be selectively connected to the frame (1) by one (B3; B2; B1) of the selective-coupling means.

11. A device according to claim 4, in which the three planetary gearsets comprise:
a first gearset (TP1), the input (E1) of which is connected to a ring gear (103) and the output (S1) is connected to a planet carrier (PS1), this first gearset being capable of a direct local drive to produce a fifth ratio, and a gear reduction by locking a sun wheel (101) to produce a third ratio;
a second gearset (TP2), the input (E2) of which is connected to a sun wheel (104) and the output (S2) is connected to a planet carrier (PS2), this second gearset being capable of a direct local drive to produce a sixth ratio, and a gear reduction by locking a ring gear (106) to produce a second ratio; and
a third gearset (TP3), the input (E3) of which is connected to a sun wheel (110) and the output (S3) is connected to a planet carrier (PS4), this third gearset being capable of a direct local drive to produce a fourth ratio, and a gear reduction by locking a ring gear (112) to produce a first ratio.

12. A device according to claim 11, characterized in that one of the planetary gearsets, preferably the third planetary gearset (TP3), moreover comprises an epicyclic gearset, the sun wheel (107) of which is connected to the input (E3), the ring gear (109) is connected to the output and the planet carrier (PS3) can be selectively locked to produce a reverse ratio.

13. A device according to claim 1, characterized in that each transmission ratio is achieved by closing a selective-coupling means of one of the planetary gearsets (TP1, TP2, TP3) and by placing or maintaining in an open state the other selective-coupling means of the transmission A device.

14. A device according to claim 1, characterized in that the selective-coupling means (B1 to B3, C4 to C6, BR) are of the progressive type and are capable of ensuring progressive adaptation between the speed of rotation of a vehicle engine and the speed of the vehicle, in particular for setting the vehicle in motion from stationary by at least one of the selective-coupling means.

15. A device according to claim 1, characterized in that the planetary gearsets (TP1 to TP3) and the transfers (TR1 to TR3) are in permanent meshing.

16. A device according to claim 1, characterized in that at least one first ratio, obtained by actuation of a first selective-coupling means (B2) between the frame (1) and an element (106) of a planetary gearset (TP2), transmits a greater torque than at least one second gear obtained by actuation of a second selective-coupling means (C6) achieving a direct local drive within said planetary gearset.

17. A device according to claim 1, characterized in that the shortest of its ratios obtained by the local direct drives (C4, C5, C6) is longer than the longest of the ratios obtained by selective coupling (BR, B1, B2, B3) between the frame (1) and an element of a planetary gearset.
